(19) United States
(12) Patent Application Publication
(10) Pub. No.: US 2026/0073241 A1
(43) Pub. Date: Mar. 12, 2026

(54) Iterative Narrowing of Options in Artificial Intelligence-Based Agent Interactions

(71) Applicant: Google LLC, Mountain View, CA (US)

(72) Inventors: Florian Nils Hartmann, Zurich (CH); Matthew Sharifi, Kilchberg (CH)

(21) Appl. No.: 18/883,763

(22) Filed: Sep. 12, 2024

(51) Int. Cl. G06N 5/01

(52) U.S. Cl. CPC G06N 5/01

(57) ABSTRACT

Provided is a system that enables machine-learned communication agents to provide automatic and iterative narrowing of possible outcome values for a particular item or parameter relative to multiple users in an effective manner that both respects the preferences of the users and is guaranteed to reach a definitive result. Communication agents can be or include machine-learned models that can act on behalf of a particular user to perform a variety of tasks associated with communication. In some examples, communication agents can receive requests from the user to perform a communication task, perform the task (e.g., usually communicating with another computing system), and provide the task result to the user. In other examples, the users can request that the agent interacts with another computer-based system to achieve a particular goal. For example, a communication agent can interface with a website to access information or access a service.

### FIELD

The present disclosure relates generally to machine-learned models. More particularly, the present disclosure relates to using machine-learned models as communication agents to automatically determine a particular outcome value from a set of possible outcome values.

### BACKGROUND

Large language models or other machine-learned models can be utilized for a variety of tasks. One potential task is to automatically perform tasks that require communication with another entity. However, traditionally, large language models seek to optimize compliance with a requested outcome. Therefore, large language models do not perform well when performing communication tasks in which direct compliance with an input is not the optimal or desired response.

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method. The method can be performed by a computing system comprising one or more processors. The method comprises determining a first set of candidate outcome values for an issue, wherein the first set of candidate outcome values are determined based, at least in part, on one or more preferences of a first user. The method further comprises receiving a second set of candidate outcome values from a second communication agent associated with a second user. The method further comprises determining a third set of candidate outcome values based on the first set and the second set of candidate outcome values. The method further comprises providing the third set of candidate outcome values as input to a first communication agent associated with the first user. The method further comprises receiving a fourth set of candidate outcome values as an output from the first communication agent, wherein the fourth set of candidate outcome values has fewer candidate outcome values than the third set of candidate outcome values. The method further comprises transmitting the fourth set of candidate outcome values to the second communication agent located at a second computing system as input. The method further comprises continuing to iteratively send and receive a set of a candidate outcome values between the first communication agent and the second communication agent until a final candidate outcome value remains in the set of candidate outcome values. The method further comprises transmitting the final candidate outcome value to a first user associated with the first communication agent and a second user associated with the second communication agent.

Another example aspect of the present disclosure is directed to a non-transitory computer-readable medium storing instructions that, when executed by one or more computing devices, cause the one or more computing devices to perform operations comprising determining a first set of candidate outcome values for an issue, wherein the first set of candidate outcome values are determined based, at least in part, on one or more preferences of a first user. The operations further comprise receiving a second set of candidate outcome values from a second communication agent associated with a second user. The operations further comprise determining a third set of candidate outcome values based on the first set and the second set of candidate outcome values. The operations further comprise providing the third set of candidate outcome values as input to a first communication agent associated with the first user. The operations further comprise receiving a fourth set of candidate outcome values as an output from the first communication agent, wherein the fourth set of candidate outcome values has fewer candidate outcome values than the third set of candidate outcome values. The operations further comprise transmitting the fourth set of candidate outcome values to the second communication agent located at a second computing system as input. The operations further comprise continuing to iteratively send and receive a set of a candidate outcome values between the first communication agent and the second communication agent until a final candidate outcome value remains in the set of candidate outcome values. The operations further comprise transmitting the final candidate outcome value to a first user associated with the first communication agent and a second user associated with the second communication agent.

Another example aspect of the present disclosure is directed to a computing system for performing iterative narrowing of options with artificial intelligence-based agents. The system can include one or more processors; and one or more non-transitory computer-readable media that collectively store an artificial intelligence-based communication agent. When executed by the one or more processors, the artificial intelligence-based communication agent is configured to perform a collaborative and iterative narrowing process to select a final outcome value for an item from a plurality of possible outcome values. The collaborative and iterative narrowing process comprises, for each of a plurality of narrowing iterations: receiving a communication from one or more other communication agents, wherein the communication specifies a current set of possible outcome values for the item. The process further comprises executing a machine-learned model to select one or more of the possible outcome values to be removed from the current set of possible outcome values. The process further comprises updating the current set of possible outcome values by removing the selected one or more possible outcome values from the current set of possible outcome values. The process further comprises transmitting the updated current set of possible outcome values to the one or more other communication agents.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 represents an example communication model in accordance with example embodiments of the present disclosure;

FIG. 2 represents an example system for using communication agents to cooperatively narrow a set of possible outcome values to select a final outcome value in accordance with example embodiments of the present disclosure;

FIG. 3 depicts an example communication agent system in accordance with example embodiments of the present disclosure;

FIG. 4 depicts a block diagram of an example computing system 100 for executing a communication agent that can iteratively narrow options between two large-language models according to example embodiments of the present disclosure;

FIG. 5 is a flow diagram representing the system for iteratively narrowing options in a large-language model process in accordance with example embodiments of the present disclosure;

FIG. 6 is a block diagram of an example processing flow for using machine-learned model(s) 1 to process input(s) 2 to generate output(s) 3;

FIG. 7 is a block diagram of an example implementation of an example machine-learned model configured to process sequences of information;

FIG. 8 is a block diagram of an example technique for populating an example input sequence 8;

FIG. 9 is a block diagram of an example computing device 98 that performs according to example embodiments of the present disclosure; and

FIG. 10 is a block diagram of an example computing device 99 that performs according to example embodiments of the present disclosure.

Reference numerals that are repeated across plural figures are intended to identify the same features in various implementations.

### DETAILED DESCRIPTION

Generally, the present disclosure is directed towards a system that enables machine-learned communication agents to provide automatic and iterative narrowing of possible outcome values for a particular item or parameter relative to multiple users in an effective manner that both respects the preferences of the users and is guaranteed to reach a definitive result. Communication agents can be machine-learned models that can act on behalf of a particular user to perform a variety of tasks associated with communication. In some examples, communication agents can receive requests from the user to perform a communication task, perform the task (e.g., usually communicating with another computing system), and provide the task result to the user. In other examples, the users can request that the agent interacts with another computer-based system to achieve a particular goal. For example, a communication agent can interface with a website to access information or access a service. In other examples the communication agents can cause an action in the real-world based upon the outcome of the communication task.

In some examples, the user can empower one or more communication agents to select a certain outcome value for a particular item, issue, or parameter on their behalf. For example, if two (or more) users need to determine a time for a meeting, the users can enable their respective communication agents to cooperatively operate to determine an appropriate time for a meeting between the two users. Thus, in this example, the time for the meeting is one example of an item, issue, or parameter. The set of all possible times for the meeting is an example of a set of available of possible outcome values. The communication agents can cooperatively operate to select a particular time for the meeting. The selected time is an example of a selected outcome value. In some embodiments the communication agents can cause a booking to be made for the particular time.

Specifically, the users can make information available to their respective communication agents. The information can include, but is not limited to: their calendars, their preferences, their current location, and the degree to which they wish to have the meeting. According to an example aspect of the present disclosure, the two (or more) communication agents can use this information to iteratively narrow a set of available times in order to select a specific time for the meeting.

More particularly, as discussed above, current machine-learned models (especially large language models) have often been trained or aligned to be obliging, such that they will agree or try to agree to requests from the other party. However, this is not an effective or helpful tactic to narrow a set of available options and to ensure that the preferences of all parties are represented. Thus, the present disclosure discusses a method for enabling these communication agents to communicate with other communication agents more effectively to iteratively narrow a set of available outcome values to ultimately select a final outcome value. In this way, the communication agent can be thought of as working with another communication agent to iteratively select an outcome value to a particular item, issue, or parameter that respects the preferences of the two or more users in a way that ensures the process will eventually conclude. The claimed techniques provide for improvements in computational efficiency of carrying out a task.

To do so, a first communication agent associated with the first user can determine an initial set of candidate outcome values. For example, an outcome can be a time for a meeting, a restaurant selection, a programming language to use for a particular project, or any other outcome that may be selected based on performing the iterative narrowing processing between two parties. The first communication agent can generate an initial set of outcomes that would be acceptable to the first user based on information provided by that first user, information available to the communication agent via data storage the user has made available (e.g., the user schedule), map information about the user's location and the location of nearby restaurants, or any other information that may be pertinent to the iterative narrowing process and that the user has explicitly made available to the communication agent.

Once the first communication agent determines an initial set of candidate outcome values, the first agent can communicate this set to the second agent. In some examples, the communication includes a natural language explanation of the iterative narrowing process, a list of candidate outcome values, and instructions to the second communication agent. In some examples, the communication can be sent via e-mail. In other examples, the communication could be sent by text, group chat, or any other communication method possible via computer networks.

The second communication agent, representing the second user, can receive the request from the first communication agent. The second communication agent can be trained to receive natural language requests as input, analyze them, and provide an output. In this example, the second communication agent can also provide an initial set of candidate outcome values. The initial set of candidate outcome values provided by the second communication can represent the preferences and availability of the second user.

Once both communication agents have determined the initial set, one or both of the communication agents can determine a third set representing all of the candidate outcome values that overlap between the first set representing the first user and the second set representing the second user. In some examples, the elements in each set have a common format or are normalized. However, if the elements of each set are not normalized or do not otherwise have a common format, the agents or another system can generate embeddings that represent each element. The systems can then calculate a distance between the embeddings (e.g., a Levenshtein distance or other distance) to determine whether two elements are the same.

In some examples, the iterative narrowing process can have an initial phase where the initial sets from the first communication agent and the second communication agent are kept “sealed” or otherwise hidden from each other. During this phase, the first and second communication agent can only share a one way hash (e.g., SHA hash) of the initial set (e.g., describing the initial preferences). Once the hashes have been exchanged, the sets of preferences can be shared. This allows both parties to check whether the preferences have been tampered with, or if they have remained unchanged (and therefore uninfluenced by what the other party's preferences were). This can also prevent one agent from modifying their initial set based on the other agent's initial set (e.g., to prevent an unscrupulous user from tying to get an advantage in the narrowing process). In some examples, the initial phase can use a cryptographic hash with some salt that is only revealed to the other communication agent after the iterative narrowing has been performed. This can prevent a brute force exploit in cases when the total number of options is relatively small (e.g., determining a meeting time).

Once this third set of candidate outcome values (e.g., the set of overlapping candidate outcome values) has been determined, one of the communication agents can analyze the current set of candidate outcome values, generate a score for each candidate outcome value within the set, and based on those scores, eliminate one or more of the candidate outcome values in the set. For example, the first communication agent can generate a score for each outcome in the set of overlapping candidate outcome values. The first communication agent can generate the score based on the preferences of the user. For example, if the possible outcomes are associated with a meeting time, the score for each candidate outcome values (e.g., specific meeting times) can represent the degree to which that specific meeting time is preferable to the user. For example, if user prefers morning meetings, meetings in the morning may receive a higher score than in the afternoon. Similarly, meeting times adjacent to other meetings may score lower if the user prefers to have a break between meetings. First, the agent can determine one or more potential outcomes with the lowest score in the set of overlapping outcomes. The communication agent can remove the lowest score option and transmit the remaining set to the second computing system.

The second communication agent can perform the same process, scoring each candidate option and removing one or more of the lowest score options. This process can continue until only one candidate outcome value remains in the set of overlapping outcomes. In this way, each communication agent can remove the least favorable outcomes until only one outcome remains. The communication agents can then agree that the remaining option is selected and transmit this information to their respective users.

In some examples, the first agent and second agent may determine that there are no common candidate outcome values between the set of initial outcomes provided by the first communication agent and the set of candidate outcome values provided by the second communication agent. In this example, the agents can add additional options to their respective set of candidate outcome values. For example, the first communication agent can add five candidate outcome values, and the second can add five candidate outcome values. Once both communication agents have added additional candidate outcome values, the two sets of candidate outcome values can be compared again to determine whether there are any overlapping candidate outcome values. This process can be continued until at least one candidate outcome value overlaps between the first set provided by the first communication agent and the second set provided by the second communication agent.

Alternatively, if the initial set of candidate options provided by the first communication agent and the initial set of candidate outcome values offered by the second communication have no overlap, each communication agent can reach out to their respective users to determine how the users would prefer that the iterative narrowing process proceed. For example, the users may determine that there is no outcome they would both agree to and cease the iterative narrowing process. In other examples, the users can provide additional instructions to the users to broaden the pool of candidate outcome values suggested by each communication agent.

In addition, each communication agent can include a method for evaluating each candidate outcome value to determine which candidate outcome value is the least preferable candidate outcome value for the associated user. For example, the communication agent may comprise a machine-learned model that generates scores for a list of outcomes or determines the lowest preferred option from a list of options. In some examples, the communication agent can use a machine learning model distinct from itself to determine the least preferred option from a set of candidate outcome values.

In some examples, the request to begin an iterative narrowing process is provided as a natural language prompt to the first communication agent. In some examples, the prompt includes instructions for a variety of topics associated with the iterative narrowing process. For example, the prompt can determine whether to use filters to reduce the number of candidate outcome values, the number of candidate outcome values to remove at each round (e.g., the more removed at each round, the faster a result is reached), and so on. For example, each subsequent round (by alternating communication agents) includes removing a predetermined number of candidate outcome values from the set of candidate outcome values. In some examples, each round removes a single candidate outcome value. In some examples, the machine-learned models can determine a number to remove at each step based on the size of the candidate outcome value said. For example, if the number of candidate outcome values exceeds a threshold value, the predetermined number can be a percentage of that total. For example, if the number of candidate outcome values in the set of possible candidate outcome values exceeds 100, the candidate communication agents can remove 1% of the candidate outcome values each round. In some examples, the number removed from each round can be based on user preference or agreed between the users associated with each communication agents.

In some examples, if the set of candidate outcome values has a number of candidate outcome values that exceed the threshold value, the candidate outcome values can be filtered using a filter before the communication agents begin evaluating and removing particular candidate outcome values. For example, if the number of candidate outcome values in the set of candidate outcome values is in the thousands, the users or communication agents can determine a filter to use to reduce the number of candidate outcome values. For example, if the iterative narrowing process is about a meeting time, the possible times can be filtered to include only those times that occur within the next month. Similarly, if the iterative narrowing process includes determining a particular restaurant for a meal, the communication agents can filter their candidate outcome values (e.g., restaurants) based on location, price, restaurant type, or other filters to reduce the total number of candidate outcome values so that the process for selecting an outcome can be more efficient.

In some examples, the communication agents can determine the particular filters to use based on the iterative narrowing process described herein. For example, a first communication agent can determine a set of potential filters that the second communication agent can review and provide feedback on. In some examples, the process for selecting filters can be the same as the process for choosing a candidate outcome value. For example, each communication agent can take turns removing potential filters until one or more filters are left. The remaining filters can be used to filter the set of candidate outcome values.

In some examples, the number of candidate outcome values removed by a communication agent at each iteration can be determined based on a relationship between the two users that are represented by the communication agents. For example, if a first user is highly motivated to set a meeting time with the second user who is less motivated (e.g., due to different levels of perceived urgency), the first user may agree to allow the second user agent to remove more outcomes at each step than the first user's communication agent does. In this way, the second user's preferences can be more represented in the final outcome than the first user's preferences. The first user can agree to this to ensure that the second user is willing to enter into an iterative narrowing process for a meeting time.

In some examples, the communication agents can perform this iterative narrowing process very quickly. As a result, the system can be improved by performing the iterative narrowing process multiple times. For example, the communication agents may provide different initial sets of candidate outcome values. In other examples, the process starts with the same initial set of candidate outcome values from each communication agent. In some examples, the outcomes of each round can be stored and used to determine the final outcome. For example, the most common outcome can be selected. In other examples, each round can be weighted, and the weighted scores can be used to determine a final result.

In some examples, each time the process of iterative narrowing is performed, the starting communication agent can be randomized. This is because the final communication agent to act (e.g., the communication agent who removes the last candidate option from the set of possible candidate outcome values) may be slightly more represented than those who do not act last. Performing the iterative narrowing process multiple times and selecting the initial starting agent randomly, the effect associated with a bias towards the last acting agent can be mitigated.

In some examples, if one of the communication agents determines that the other agents are not acting in accordance with the general guidelines of the process (e.g., not removing the agreed-upon number of candidate outcome values or ignoring the candidate outcome values removed by the other agent), a communication agent can remove itself from the iterative narrowing process and notify the user that communication agents were not able to achieve a result.

The systems and methods of the present disclosure provide a number of technical effects and benefits. As one example, the systems and methods can provide an automatic resolution for an iterative narrowing process between two users without the need for either user to manual provide input. As such, the system can significantly reduce the time needed to reach an agreement and can do so in a transparent manner.

Furthermore, the method and system provide a technical benefit by subdividing a large group of candidate outcome values and performing the described iterative narrowing process in parallel for each subgroup. Once a candidate outcome value has been selected for each subgroup, the selected candidate outcome values can be grouped, and the iterative narrowing process can be repeated. This is especially useful in situations in which the communication delay is significant. By selectively performing multiple the iterative narrowing process processes in parallel (e.g., based on the communication delay), the computing system can reduce the overall time needed to reach an acceptable outcome while also reducing the cost of processing and overall bandwidth. Doing so can result in improved computational efficiency and improvements in the functioning of a computing system.

With reference now to the Figures, example embodiments of the present disclosure will be discussed in further detail.

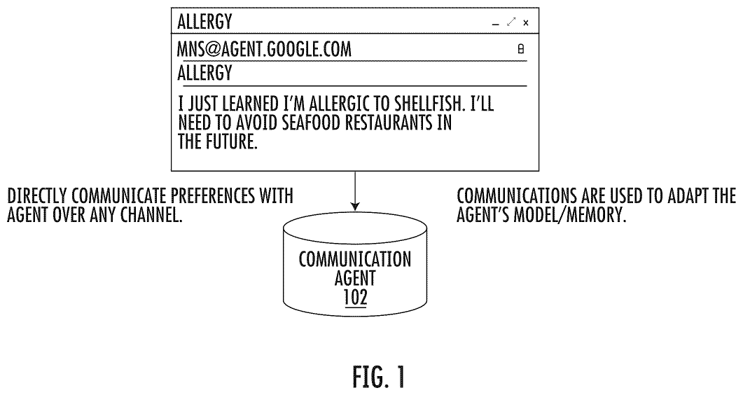

FIG. 1 represents an example communication model 102 in accordance with example embodiments of the present disclosure. In this example, a communication agent 102 can include a machine-learned model. The machine-learned model can be trained to represent users' preferences and communicate on their behalf in specific contexts. The communication agent 102 can only act in the context that the user has specifically asked them to act, and all user data that the user has explicitly provided to the communication agent.

The user can communicate directly with the model to provide information about the user and their preferences. In this example, the user can directly communicate with the agent using an e-mail 104 describing one or more pieces of information. The model can store or incorporate this data to be used in future communications on behalf of the user. Direct instructions from the user can be integrated into the machine-learned model or the information model and/or stored in memory the machine-learned model has access to.

In some examples, as the communication agent performs tasks on behalf of the user, the user can provide feedback indicating how the model performed. For example, the user can note when the communication agent 102 has performed well. In addition, the user can notify the communication agent 102 has made a mistake with regards to the user's preferences or has provided incorrect information. In this way, the communication agent 102 can improve the accuracy of its model based on direct communication from the user. The communication agent can also improve its accuracy based on indirect communication from the user. In this way, the communication agent will improve its ability to represent the user adequately when performing tasks. One task the communication agent can perform is the iterative narrowing process with other communication agents to resolve an issue on behalf of their respective users.

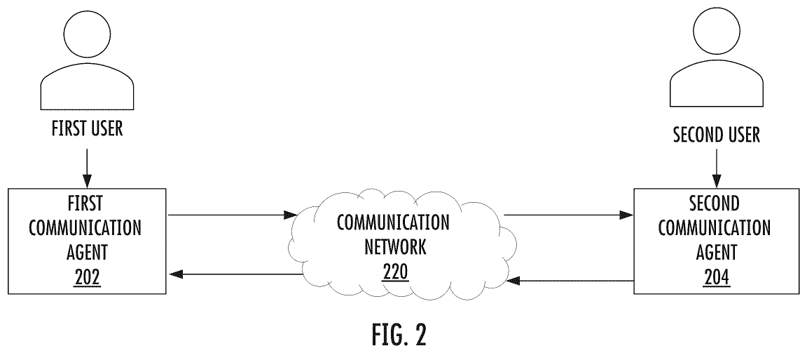

FIG. 2 represents an example system for using communication agents to cooperatively narrow a set of possible outcome values to select a final outcome value in accordance with example embodiments of the present disclosure. In this example, a first communication agent 202 can receive input from a first user. The input can be a request to perform an iterative narrowing process. The request can include information about the user's preferences, instructions on performing the iterative narrowing process, and a natural language prompt describing how that iterative narrowing process should be performed. The request can also include information about the communication method used for the iterative narrowing process and how to contact the other communication agent. For example, the request can include an email address, IP address, or other information that enables the first communication agent 202 to contact the second communication agent 204.

If a first user wishes to determine an outcome value for a particular item, issue, or parameter, the user can communicate with a first communication agent 202. A communication agent can comprise a machine learning model that takes prompts from users as input and outputs a response based on the user. Specific communication models can be trained to act as a proxy for a particular user. Thus, the communication agent can receive data about the user's preferences, cither through explicit instructions from the user, or based on data provided by the user, including a user profile, a user history, emails, calendar information, search history, and any other information the user provides that may be useful in determining the specific preferences of the user.

In some examples, the communication agent can receive feedback from the user as it performs tasks and updates its internal representation of the user's preferences (e.g., based on characteristics of a machine-learned model such as weight of connections between nodes in different layers of the model). In this way, the communication agent and its associated one or more machine-learned models can incorporate information about the user's preferences. As a result, the accuracy with which the communication agent represents the user's preferences can increase over time.

In this example, the user can instruct the first communication agent 202 to perform a particular iterative narrowing process and can instruct the first communication agent 202 to perform this iterative narrowing process with the second communication agent 204, which represents a second user.

The iterative narrowing process request can also include information about the outcomes that the first user finds acceptable. This information could include the user's current schedule (e.g., if the particular item, issue, or parameter is an appointment time), or the user's food and activity preferences for scoring potential options. The first communication agent 202 can use this information to evaluate candidate outcome values and to determine an outcome value that is acceptable to the first user.

The first communication agent 202 can communicate with the second communication agent 204 to determine whether the second communication agent 204 is willing to perform an iterative narrowing process on behalf of the second user. In some examples, the first and second users have already communicated and decided to allow their respective communication agents to perform this iterative narrowing process. As such, an initial introductory communication may not be needed. However, if such an agreement has not already been made, the first communication agent 202 can request that the second communication agent query the second user to determine whether the iterative narrowing process is acceptable to the second user.

In some examples, the request can include the topic of the iterative narrowing process and an initial set of acceptable candidate outcome values from the first communication model. As noted above, this first initial set may be based on direct instruction from the user or may be generated by the first communication agent itself based on existing information about the user's preferences and past iterative narrowing processes.

In some examples, the first communication agent 202 can transmit the initial set of candidate outcome values to the second communication agent 204 via a communication network 220. The second communication agent 204 can compare the initial set of candidate options provided by the first communication agent 202 to the initial set of candidate options provided by the second communication system 204 to determine a set of overlapping candidate outcome values.

In some examples, once the second communication agent 204 has determined the set of candidate outcome values that were listed in the both sets of initial candidate outcome values provided by the communication agents, the set of candidate outcome values can be transmitted to the first communication agent 202. The first communication agent 202 can analyze the set of candidate outcome values that the two initial sets have in common. Based on this analysis, the first communication agent 202 can remove one or more candidate outcome values from the set of candidate outcome values. Note that each communication agent must remove at least one outcome from the set of candidate outcome values each time they receive the set of candidate outcome values until only one outcome value remains.

Once the first communication agent 202 has removed at least one candidate outcome value from the set of candidate outcome values, the first communication agent 202 can transmit the resulting set of candidate outcome values (e.g., which has been modified to remove at least one candidate outcome value) to the second communication agent 204. The second communication agent 204 can perform the same process, evaluating the candidate outcome values and removing at least one candidate outcome value from the set. As an initial part of the iterative narrowing process, the two agents may have determined a number of candidate outcome values to remove at each step in this process. The two communication agents (or more than two in situations where multiple users need to perform the iterative narrowing process), can iteratively take turns removing candidate outcome values from the set of candidate outcome values until only one candidate outcome value remains.

Once the set of candidate outcome values has been reduced to a candidate outcome value, the remaining candidate outcome value is determined to be the selected outcome. In some examples, this process can be repeated multiple times, and the most common outcome of this process can be selected. For example, if the process is repeated 100 times, the two or more communication agents can select the most common outcome as the agreed-upon result of the iterative narrowing process. The agreed-upon result can be transmitted to each user as the final result of the iterative narrowing process.

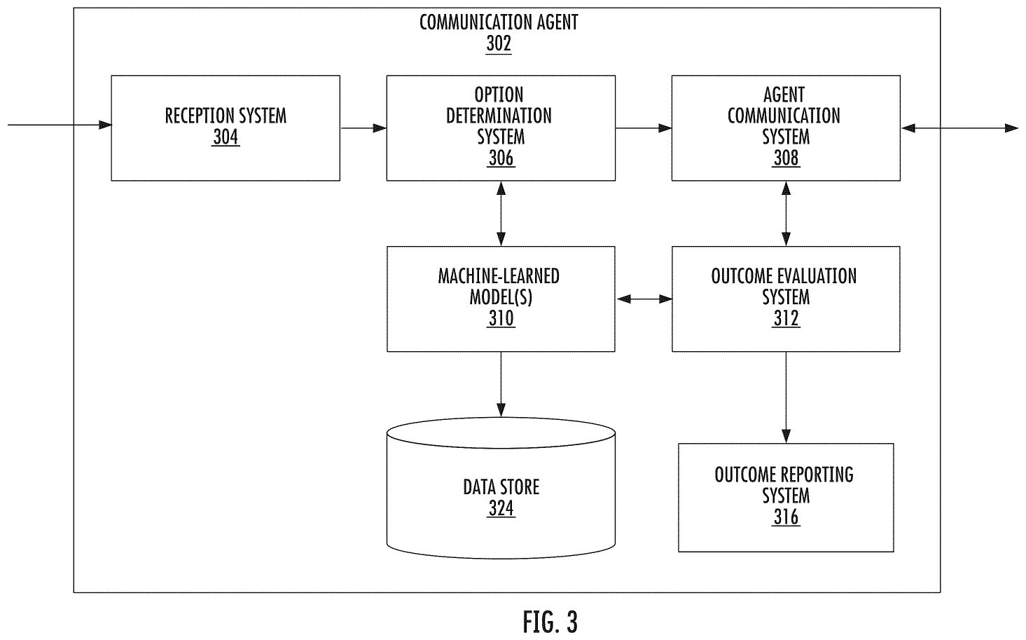

FIG. 3 depicts an example communication agent system in accordance with example embodiments of the present disclosure. In this example, communication agent 302 can include multiple components. For example, the communication agent 302 can include a reception system 304, an option determination system 306, a communication system 308, one or more machine-learned models 310, an outcome reporting system 316, and a data store 324. In this example, the components of the communication agent system 302 can be understood as code modules, physical system components, or representations of the processes performed by a single system (e.g., the communication agent 302), but without specific independent components within the system as depicted.

In this example, the reception system 304 can receive, from a user, a request to perform a particular action. The request can be provided as a natural language prompt in some examples. The prompt can be a request to perform an iterative narrowing process with respect to some particular item, issue, or parameter. For example, the request can include, in natural language, an identification of an issue that needs to be resolved with another party. These issues can include but are not limited to determining a time to meet, selecting a place or activity to perform, choosing a common item to buy or rent, determining an advertisement to display, or any other issue in which a decision needs to be made between two or more parties. The outcome can be represented as a plurality of distinct possible outcomes.

The reception system 304 can receive the request from the user and provide details to an option determination system 306. The option determination system 306 can determine one or more potential candidate outcome values for the specific issue based on the request. In one example, the issue at hand is a time to meet with another user. In this example, the candidate outcome values can be a plurality of possible time slots. In some examples, the candidate outcome values can include a location for the meeting, the time of the meeting, and the duration of the meeting. The prediction system 306 can access a machine-learned model 310 to generate a list of candidate outcome values for the issue. For the example of a meeting time, the candidate outcome values can be a plurality of times at which the user is available and probably of locations at which the user can meet. In some examples, each potential time slot can have one or more associated locations such that not all times are available for all locations, and not all locations are available at all times.

In some examples, the machine-learned model 310 can access the data store 324, including the user's current calendar schedule and/or location data. The machine-learned model 310 can then take input from the option determination system 306, describe the issue, and provide instructions as to the user preferences or any particular requests included with the received request. The machine-learned model 310 can generate an output. In this case, the output can be a set of candidate outcome values that are acceptable to the user who made the original request.

The initial set of candidate outcome values generated by the option determination system 304 can be provided to the agent communication system 308. The agent communication system 308 can communicate with different agents representing different users. The other communication agent (not pictured) can provide the communication agent 302 with its initial set of candidate outcome values.

The agent communication system 308 can provide the set of candidate outcome values offered by the communication agent to the outcome evaluation system 312. The outcome evaluation system 312 can initially determine the common outcomes between the set of candidate outcome values provided by the first communication agent 302 and the set of candidate outcome values provided by a second communication agent (the other party in the iterative narrowing process which is not shown). The outcome evaluation of 312 can generate a modified set of outcomes based on the overlap between the two sets.

The outcome evaluation system 312 can then analyze each candidate outcome value in the set of overlapping candidate outcome values. In some examples, the outcome evaluation system 302 can use one or more machine-learned model 310 to generate a preference score for each candidate outcome value in the set of candidate outcome values. For example, the machine-learned model 310 can access data in the data store 324 that represents the user's preferences and other data provided by the user. Based on this information, the machine-learned model 310 can output a value representing the degree to which each candidate outcome value is agreeable to the user. The outcome evaluation system 312 can select candidate outcome values to eliminate based on the preference scores. Once one or more candidate outcome values have been removed from the set, the outcome evaluation system 302 can transmit the modified set to the agent communication system 308.

The agent communication system 308 can transmit the modified set of candidate outcome values to another communication agent. The other communication agent can remove the same number of candidate outcome values as were removed by the outcome evaluation system 312. This process can be repeated until only one candidate outcome value remains in the set of candidate outcome values. The outcome reporting system 316 can determine that the remaining candidate outcome value is the result of the iterative narrowing process. The outcome reporting system 316 can report the result of the iterative narrowing process to the user.

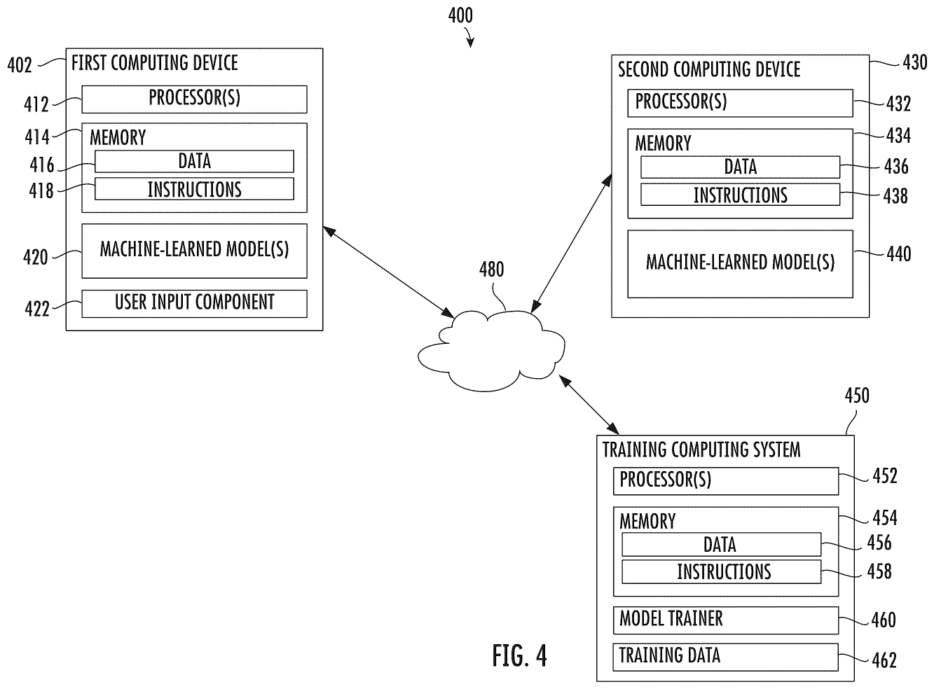

FIG. 4 depicts a block diagram of an example computing system 400 for executing a communication agent that can iteratively narrow options in an iterative narrowing process between two large-language models according to example embodiments of the present disclosure. The computing system 400 includes a first computing device 402, a second computing device 430, and a training computing system 450 that are communicatively coupled over a network 480.

The first computing device 402 can be any type of computing device, such as a personal computing device (e.g., laptop or desktop), a mobile computing device (e.g., smartphone or tablet), a gaming console or controller, a wearable computing device, an embedded computing device, or any other type of computing device.

The user computing device 402 includes one or more processors 412 and a memory 414. The one or more processors 412 can be any suitable processing device (e.g., a processor core, a microprocessor, an ASIC, an FPGA, a controller, a microcontroller, etc.) and can be one processor or a plurality of processors that are operatively connected. The memory 414 can include one or more non-transitory computer-readable storage mediums, such as RAM, ROM, EEPROM, EPROM, flash memory devices, magnetic disks, etc., and combinations thereof. The memory 414 can store data 416 and instructions 418, which are executed by the processor 412 to cause the user computing device 402 to perform operations.

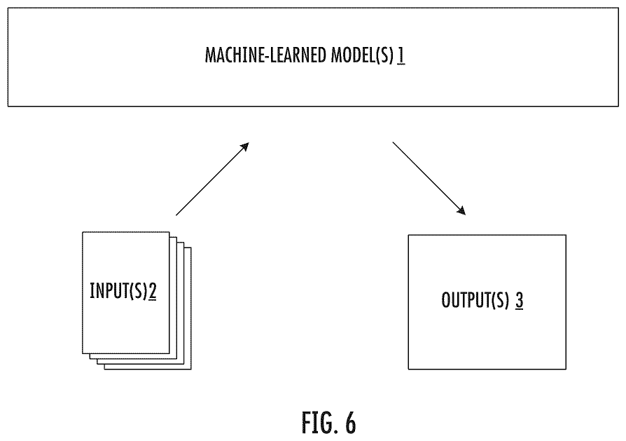

In some implementations, the user computing device 402 can store or include one or more machine-learned models 420 (e.g., one or more communication agents). For example, the machine-learned models 420 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Example machine-learned models 420 are discussed with reference to FIGS. 6-10.

In some implementations, the one or more machine-learned models 420 can be received from a server computing system over network 480, stored in the user computing device memory 414, and then used or otherwise implemented by the one or more processors 412. In some implementations, the user computing device 402 can implement multiple parallel instances of a single machine-learned model 420.

More particularly, the machine-learned model 420 (e.g., a component of a first communication agent) can receive requests from a user to conduct an iterative narrowing process with a second machine-learned model 440 (e.g., a component of a second communication agent) to determine an outcome for the iterative narrowing process. In some examples, the request can include a description of the particular item, issue, or parameter, one or other parties that should be involved in the iterative narrowing process, the user's preferences and constraints, and any other information needed to initiate and conduct the iterative narrowing process. In some examples, the request can also indicate the medium over which the iterative narrowing process is to be communicated. For example, communication between two or more communication agents can be conducted via e-mail messages between the first and second communication agents. Alternatively, two or more communication agents can communicate via a chat interface or via an API available on the first computing device 402 and the second computing device 410.

Based on the request, the first communication agent can generate an initial set of candidate outcome values for the iterative narrowing process. For example, the candidate outcome values can include a time for a meeting, a place to meet, a restaurant at which to cat, a computing language to use for a particular project, an advertisement to display to a user, or any other iterative narrowing process that may have a number of discrete selectable options. In some examples, the user can direct, in the request, the initial set of candidate outcome values for the iterative narrowing process. In other examples, the request can direct the communication agent to a source of data from which to generate the set of candidate outcome values. For example, the request can indicate that the communication agent should access the user's calendar or profile for information about their preferences or schedule. The request can include a link to the additional information in some examples.

In some examples, the communication agent can access information, user preferences, and searchable databases to generate an initial set of candidate outcome values. Each outcome represents a potential discrete resolution to the iterative narrowing process. For example, if the iterative narrowing process is about a meeting time, each candidate outcome value can be a specific time slot.

The communication agent can also transmit a request to the second communication agent. The request can indicate that the first communication agent would like to perform an iterative narrowing process with the second communication agent. The request can also include the subject of the iterative narrowing process and provide details of the iterative narrowing process. In some examples, the iterative narrowing process can be previously arranged between users of the communication agents such that the request from the first communication agent needs only to notify the second communication agent that the iterative narrowing process has begun. In other examples, the second communication agent can confirm the iterative narrowing process with its respective users to receive their preferences. In this way, the first communication agent can initiate an iterative narrowing process with a second communication agent (and its respective user) automatically. Thus, the second user may enable the second communication agent to respond to the request automatically without speaking directly to the first user.

Once the second communication agent receives the request, it can provide its initial set of potential outcomes. As with the first communication agent, this initial set can be based on the user's preferences, a set of acceptable outcomes provided by the user, information received from the user's calendar or other information from the user profile, and information obtainable via web searches or other sources. The first communication agent (or the second communication agent) can determine, based on the initial set provided by the first communication agent and the initial set provided by the second communication agent, a set of candidate outcome values that overlaps between the initial set of candidate outcome values provided by a first communication agent and the second initial set of candidate outcome values provided by the second communication agent. The overlapping set of candidate outcome values can be the basis of the iterative narrowing process.

Once the overlapping set of candidate outcome values has been determined, each communication agent can, in turn, receive the overlapping set, evaluate all of the current candidate outcome values in the set, and eliminate a predetermined number of candidate outcome values from the set. For example, each communication agent can receive the set of overlapping candidate outcome values, remove the least favorable candidate outcome value, and transmit the modified overlapping set to the other agent.

In some examples, if the set of candidate outcome values is extensive, more outcomes can be removed at each round. In addition, filters can be used to reduce a large or infinite set of candidate outcome values to a manageable size. The greater the number of candidate outcome values removed at each round, the faster the communication agents will reach a resolution.

In some examples, once only one candidate outcome value remains in the set of overlapping outcomes, that outcome can be determined to be the resolution to the iterative narrowing process. In some examples, the iterative narrowing process can be executed multiple times, and the selected outcome can be based on the most chosen outcome.

Once the communication agents have resolved an iterative narrowing process, each communication agent can transmit their resolution to their respective users to notify the user of how the iterative narrowing process was resolved. In some examples, if one of the communication agents is not acting according to the base rules of iterative narrowing process, either communication agent can withdraw and cease the iterative narrowing process.

Alternatively, one or more machine-learned models 420 (e.g., one or more communication agents or scoring models) can be included in or otherwise stored and implemented by the second computing device 430 that communicates with the first computing device 402 according to a client-server relationship. For example, the one or more machine-learned models 420 can be implemented by a server computing system as a portion of a web service (e.g., as part of a query response service). Thus, one or more models 420 can be stored and implemented at the first computing device 402, one or more models 440 can be stored and implemented at the second computing device 430, and/or one or more models can be stored at and implemented by a server computing system.

The user computing device 402 can also include one or more user input component 422 that receives user input. For example, the user input component 422 can be a touch-sensitive component (e.g., a touch-sensitive display screen or a touchpad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The second computing device 430 includes one or more processors 432 and a memory 434. The one or more processors 432 can be any suitable processing device (e.g., a processor core, a microprocessor, an ASIC, an FPGA, a controller, a microcontroller, etc.) and can be one processor or a plurality of processors that are operatively connected. The memory 434 can include one or more non-transitory computer-readable storage mediums, such as RAM, ROM, EEPROM, EPROM, flash memory devices, magnetic disks, etc., and combinations thereof. The memory 434 can store data 436 and instructions 438 which are executed by the processor 432 to cause the second computing device 430 to perform operations.

In some implementations, the second computing device 430 includes or is otherwise implemented by one or more server computing devices. In instances in which the second computing device 430 includes plural server computing devices, such server computing devices can operate according to sequential computing architectures, parallel computing architectures, or some combination thereof.

As described above, the second computing device 430 can store or otherwise include one or more machine-learned models 440 (e.g., one or more image communication agents or scoring models). For example, the models 440 can be or can otherwise include various machine-learned models. Example machine-learned models include neural networks or other multi-layer non-linear models. Example neural networks include feed forward neural networks, deep neural networks, recurrent neural networks, and convolutional neural networks. Example models 440 are discussed with reference to FIGS. 6-10.

The first computing device 402, the second computing device 430 and/or a server computing system can train the models 420 and/or 440 via interaction with the training computing system 450, which is communicatively coupled over the network 480. The training computing system 450 can be separate from or a portion of the server computing system.

The training computing system 450 includes one or more processors 452 and a memory 454. The one or more processors 452 can be any suitable processing device (e.g., a processor core, a microprocessor, an ASIC, an FPGA, a controller, a microcontroller, etc.) and can be one processor or a plurality of processors that are operatively connected. The memory 454 can include one or more non-transitory computer-readable storage mediums, such as RAM, ROM, EEPROM, EPROM, flash memory devices, magnetic disks, etc., and combinations thereof. The memory 454 can store data 456 and instructions 458 which are executed by the processor 452 to cause the training computing system 450 to perform operations. In some implementations, the training computing system 450 includes or is otherwise implemented by one or more server computing devices.

The training computing system 450 can include a model trainer 460 that trains the machine-learned models 420 and/or 440 stored at the first computing device 402, the second computing device 430 and/or the server computing system using various training or learning techniques, such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations.

In some implementations, performing backwards propagation of errors can include performing truncated backpropagation through time. The model trainer 460 can perform a number of generalization techniques (e.g., weight decays, dropouts, etc.) to improve the generalization capability of the models being trained.

In particular, the model trainer 460 can train the image generation system and the classifiers based on a set of training data 462. The training data 462 can include, for example, example ratings of various types of outcomes for an iterative narrowing process, user preference data, schedule data, and so on.

The model trainer 460 includes computer logic utilized to provide desired functionality. The model trainer 460 can be implemented in hardware, firmware, and/or software controlling a general-purpose processor. For example, in some implementations, the model trainer 460 includes program files stored on a storage device, loaded into a memory and executed by one or more processors. In other implementations, the model trainer 460 includes one or more sets of computer-executable instructions that are stored in a tangible computer-readable storage medium such as RAM hard disk or optical or magnetic media.

The network 480 can be any type of communications network, such as a local area network (e.g., intranet), wide area network (e.g., Internet), or some combination thereof and can include any number of wired or wireless links. In general, communication over the network 380 can be carried via any wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

The machine-learned models described in this specification may be used in a variety of tasks, applications, and/or use cases. In some implementations, the input to the machine-learned model(s) of the present disclosure can include image data. The machine-learned model(s) can process the image data to generate an output based on a request. As an example, the machine-learned model(s) can process the image data to generate a new image by extracting information from the image data and updating or modifying it based on the request.

In some implementations, the input to the machine-learned model(s) of the present disclosure can be text or natural language data. The machine-learned model(s) can process the text or natural language data to generate an output. As an example, the machine-learned model(s) can process the natural language data to a particular image request and generate a prompt based on the image request.

In some implementations, the input to the machine-learned model(s) of the present disclosure can be speech data. The machine-learned model(s) can process the speech data to generate an output. As an example, the machine-learned model(s) can process the speech data to generate a speech recognition output. The output of the speech recognition system can be used as input to the image generation model.

FIG. 4 illustrates one example computing system that can be used to implement the present disclosure. Other computing systems can be used as well. For example, in some implementations, the first computing device 402 can include the model trainer 460 and the training dataset 462. In such implementations, the model(s) 420 can be trained and used locally at the user computing device 402. In some implementations, the user computing device 402 can implement the model trainer 460 to personalize the models 420 based on user-specific data.

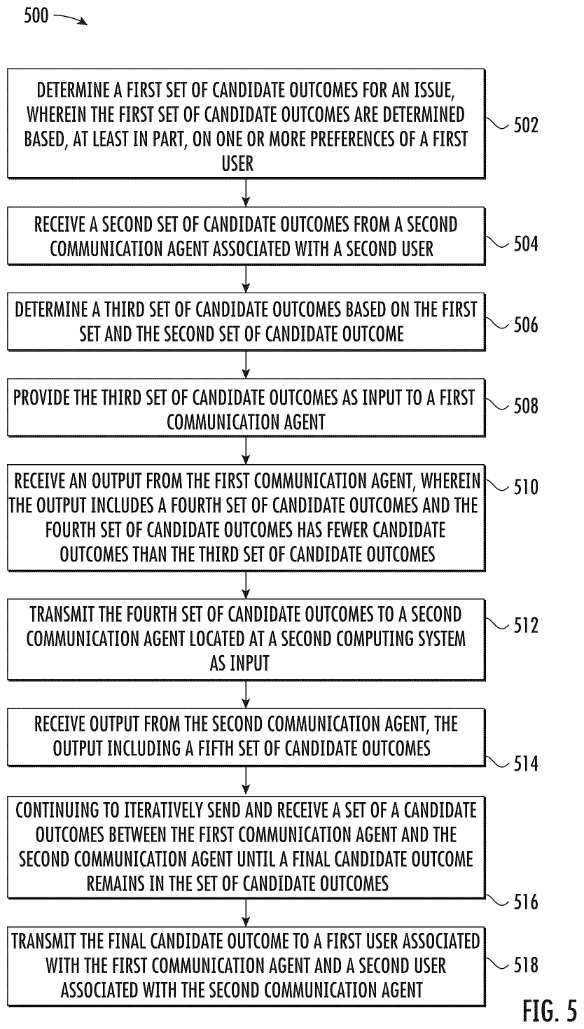

FIG. 5 is a flow diagram representing the system for iteratively narrowing options using one or more large-language models in accordance with example embodiments of the present disclosure. A computing system with one or more processors can perform a method. The method can include, at 502, determining a first set of candidate outcome values for an issue, wherein the first set of candidate outcome values are determined based, at least in part, on one or more preferences of a first user. In some examples, each candidate outcome value is associated with a performance of a particular task.

For example, a candidate outcome value can be a particular time and/or location for a meeting, a restaurant to eat out at, a programming language to use for a project, a temperature for a common space, an advertisement to display to a user, and so on. Each candidate outcome value can represent a distinct option from a plurality of potential options.

In some examples, the first communication agent is trained or prompted based on the preferences of the first user. The preferences of the first user can be supplied to the communication agent for training directly by the first user. For example, the first user can describe, in natural language, the first user's preferences based with respect to one or more issues. The user can provide those preferences via an email or chat interface. In some examples, the user can make user profile data available to the first communication agent. The communication agent can use user profile data to train the agent (or an associated machine-learned model) to evaluate a user's preference more accurately. The user profile data can include demographic data, search history, web page access history, and history with the communication agent itself.

The computing system can, at 504, receive a second set of candidate outcome values from a second communication agent associated with a second user. The computing system can, at 506, determine a third set of candidate outcome values based on the first set and the second set of candidate outcome values. In some examples, to determine the third set of candidate outcome values, the computing system can compare the first set of candidate outcome values and the second set of candidate outcome values to identify one or more candidate outcome values that are present in both sets. The computing system can generate the third set of candidate outcome values based on the one or more candidate outcome values that are present in both sets. Thus, the third set of candidate outcome values represent all the candidate options that were present in the initial sets provided by both the first communication agent and the second communication agent.

In some examples, the computing system can determine that the first set of candidate outcome values and the second set of candidate have no candidate outcome values that are present in both sets. This occurs when the first set of candidate outcome values provided by the first communication agent and the second set of candidate outcome values provided by the second communication agent have no candidate outcome values in common.

Responsive to determining that the first set of candidate outcome values and the second set of candidate have no candidate outcome values that are present in both sets, the computing system can generate an input to the first communication agent requesting that a predetermined number of candidate outcome values to be added to the first set. The computing system can generate an input to the second communication agent requesting that the predetermined number of candidate outcome values to be added to the set.

The computing system can continue to generate requests for additional candidate outcome values until the first set of candidate outcome values and the second set of candidate have at least one candidate outcome value that is present in both the first set and the second set. In some examples, this process can ensure that at least one candidate outcome value is in both the sets submitted by the first communication agent and the second communication agent. However, the computing system may determine that if, after a predetermined number of added candidate outcome values by each communication agent, the sets submitted have no candidate outcome values in common, the iterative narrowing process can be determined to be a failure, and the failure can be reported to the users. Furthermore, either communication agent can report that no more acceptable candidate outcome values exist and thus no iterative narrowing process can occur.

In some examples, the computing system can apply a filter to the third set of candidate outcome values to reduce the total number of candidate outcome values in the third set of candidate outcome values. For example, if the iterative narrowing process is associated with selecting a restaurant for a group of two or more people, the potential restaurants may first be filtered based on distance, price, food type, and so on, to reduce the total number of candidate options. In some examples, the communication agent can use an iteratively narrowing process as described herein to identify which filters to use, if any.

In some examples, the computing system can divide the third set of candidate outcome values into a plurality of distinct subsets. In some examples, the third set is only divided into a plurality of distinct subsets when the set of candidate outcome values exceeds a predetermined size. In some examples, the computing system can analyze the number of options in the third set of candidate options to determine whether it exceeds the predetermined number. The predetermined number can be determined based on the speed of communication between the first and second communication agents. Thus, if the communication agents communicate via email, the predetermined number may be lower than if the communication agents communicate directly via an API. In this way, if the communication takes longer, the system is more likely to divide the set into subsets for increased efficiency.

In some examples, the computing system can perform the process of iteratively removing candidates from each subset in the plurality of distinct subsets in parallel. For example, the computing system can allow the iterative narrowing process described herein to be performed in parallel on a plurality of subsets. In some examples, the computing system gathers a final candidate outcome value for each subset into a final set of candidate outcome values. The computing system can the process of iteratively removing candidate outcome values from the final set of candidate outcome values to determine final candidate outcome value.

In some examples, the computing system can, at 508, provide the third set of candidate outcome values as input to a first communication agent. In some examples, the input to the first communication agent includes instructions to remove a predetermined number of candidate outcome values from the third set of candidate outcome values. In some examples, the input can be a natural language prompt that explains the particular process to be used in the iterative narrowing process.

The computing system can, at 510, receive an output from the first communication agent, wherein the output includes a fourth set of candidate outcome values, and the fourth set of candidate outcome values has fewer candidate outcome values than the third set of candidate outcome values. In some examples, the output from the first model includes a natural language prompt for the second communication agent that instructions the second communication agent includes instructions to remove predetermined number of candidate outcome values from the fourth set of candidate outcome values. The first communication agent can be trained to generate a preference score for each candidate outcome value in the third set of candidate outcome values. The first communication agent can remove a predetermined number of candidate options from the plurality of candidate options based on the preference score.

In some examples, the preference score for a respective candidate outcome value is determined based on stored information about the preferences of the user associated with the respective communication agent. For example, the communication agent (or an associated machine-learned model) can be trained to take a list of candidate options as input and return a ranking of those candidate outcome values with associated preference scores. The communication agent can use the preference scores to eliminate a predetermined number of candidate options from the set of candidate options (e.g., the candidate options with the lowest scores). The predetermined number can be 1. In other examples, the predetermined number can be determined based on the number of candidate outcome values in the third set of candidate outcome values. For example, the predetermined number can be set such that approximately 5% of the candidate outcome values are removed from the set of candidate outcome values at each iteration.

The computing system can, at 812, transmit the fourth set of candidate outcome values to a second communication agent located at a second computing system as input. In some examples, the fourth set of candidate outcome values are transmitted to the second communication agent using email. Alternatively, the communication agents can communicate using an instant message system, via direct communication using APIs, or any other method of communication usable via communication networks.

The computing system can, at 814, receive output from the second communication agent, the output including a fifth set of candidate outcome values. Once the first communication agent has received the output from the second communication agent, the two communication agents can, at 816, continuing to iteratively send and receive a set of a candidate outcome values between the first communication agent and the second communication agent until a final candidate outcome value remains in the set of candidate outcome values. The computing system can, at 818, transmit the final candidate outcome value to a first user associated with the first communication agent and a second user associated with the second communication agent. In some examples, the computing system can transmit instructions to perform a task based on the final candidate outcome value. The task can be displaying an advertisement associated with the final candidate outcome value. The task can be booking a reservation at a restaurant associated with the final candidate outcome value. The task can be adding a meeting to a calendar based on the final candidate outcome value.

FIG. 6 is a block diagram of an example processing flow for using machine-learned model(s) 1 to process input(s) 2 to generate output(s) 3.

Machine-learned model(s) 1 can be or include one or multiple machine-learned models or model components. Example machine-learned models can include neural networks (e.g., deep neural networks). Example machine-learned models can include non-linear models or linear models. Example machine-learned models can use other architectures in lieu of or in addition to neural networks. Example machine-learned models can include decision tree based models, support vector machines, hidden Markov models, Bayesian networks, linear regression models, k-means clustering models, etc.

Machine-learned model(s) 1 can be or include, or otherwise be representative of any one or more of the machine-learned models described above with respect to the preceding figures. For example, machine-learned model(s) 1 can be or include, or otherwise be representative of a message generation model. Although various features, variations, and implementations described below are described with respect to machine-learned model(s) 1, it is to be understood that such features, variations, and implementations are to be understood as described with respect to the message generation model, etc., any other machine-learned component described herein.

Example neural networks can include feed-forward neural networks, recurrent neural networks (RNNs), including long short-term memory (LSTM) based recurrent neural networks, convolutional neural networks (CNNs), diffusion models, generative-adversarial networks, or other forms of neural networks. Example neural networks can be deep neural networks. Some example machine-learned models can leverage an attention mechanism such as self-attention. For example, some example machine-learned models can include multi-headed self-attention models.

Machine-learned model(s) 1 can include a single, or multiple instances of the same model configured to operate on data from input(s) 2. Machine-learned model(s) 1 can include multiple different models or multiple different model portions configured to operate on data from input(s) 2.

Machine-learned model(s) 1 can include an ensemble of different models that can cooperatively interact to process data from input(s) 2. For example, a model ensemble can include multiple models that have different attributes (e.g., different architectures, trained with different recipes, etc.). The ensemble can output an overall output based on the individual outputs of the constituent models. In this manner, for instance, the diverse constituent models can work together to provide system-level robustness by effectively aggregating over individual strengths and weaknesses of any given model. The respective individual outputs can be combined in a weighted combination, using a voting or routing mechanism, or a learned output layer (e.g., one or more feedforward or fully-connected layers).

Machine-learned model(s) 1 can employ a mixture-of-experts structure. Sec, e.g., Zhou et al., Mixture-of-Experts with Expert Choice Routing, arXiv: 2202.09368v2 (Oct. 14, 2022). For example, different portions of a model can learn (explicitly or implicitly) different expertise areas, with pathways through the model being selected by a learned routing mechanism that engages the appropriate expert for a given input (e.g., a given portion of an input, such as on a per-token basis). For example, a feedforward network can be sparsely activated for a given portion of an input based on an output of a routing mechanism that processes the portion of the input. In this manner, for instance, the group of activated weights can form an “expert” that is selected by the router. On each forward pass, only a subset of the total model weights may be engaged, thereby decreasing a quantity of operations performed for processing a given input compared to a densely activated model. In this manner, for instance, the expressive and interpretive power of a high-parameter-count model can be achieved with more compute-efficient forward passes.

Input(s) 2 can generally include or otherwise represent various types of data. Input(s) 2 can include one type or many different types of data. Output(s) 3 can be data of the same type(s) or of different types of data as compared to input(s) 2. Output(s) 3 can include one type or many different types of data.

Example data types for input(s) 2 or output(s) 3 include natural language text data, software code data (e.g., source code, object code, machine code, or any other form of computer-readable instructions or programming languages), machine code data (e.g., binary code, assembly code, or other forms of machine-readable instructions that can be executed directly by a computer's central processing unit), assembly code data (e.g., low-level programming languages that use symbolic representations of machine code instructions to program a processing unit), genetic data or other chemical or biochemical data, image data, audio data, audiovisual data, haptic data, biometric data, medical data, financial data, statistical data, geographical data, astronomical data, historical data, sensor data generally (e.g., digital or analog values, such as voltage or other absolute or relative level measurement values from a real or artificial input, such as from an audio sensor, light sensor, displacement sensor, etc.), and the like. Data can be raw or processed and can be in any format or schema.

In multimodal inputs 2 or outputs 3, example combinations of data types include image data and audio data, image data and natural language data, natural language data and software code data, image data and biometric data, sensor data and medical data, etc. It is to be understood that any combination of data types in an input 2 or an output 3 can be present.

An example input 2 can include one or multiple data types, such as the example data types noted above. An example output 3 can include one or multiple data types, such as the example data types noted above. The data type(s) of input 2 can be the same as or different from the data type(s) of output 3. It is to be understood that the example data types noted above are provided for illustrative purposes only. Data types contemplated within the scope of the present disclosure are not limited to those examples noted above.

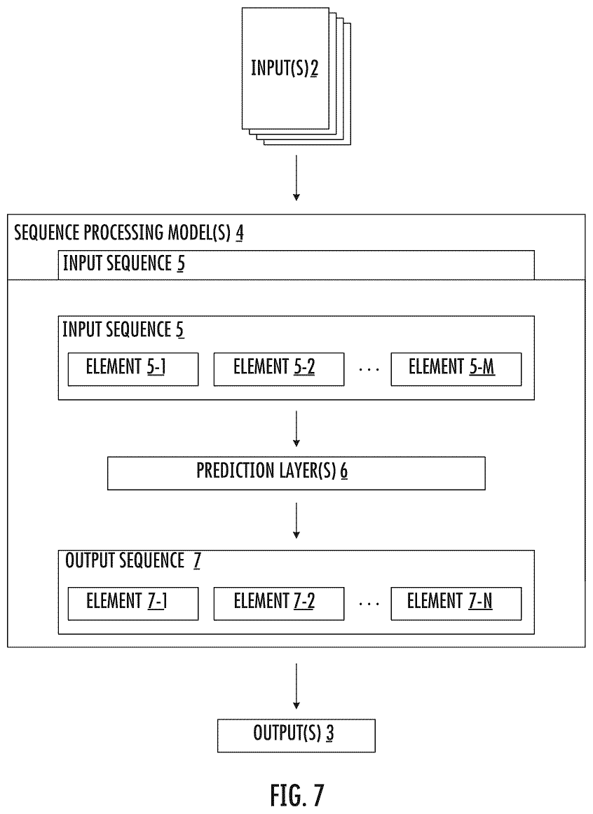

FIG. 7 is a block diagram of an example implementation of an example machine-learned model configured to process sequences of information. For instance, an example implementation of machine-learned model(s) 1 can include machine-learned sequence processing model(s) 4. An example system can pass input(s) 2 to sequence processing model(s) 4. Sequence processing model(s) 4 can include one or more machine-learned components. Sequence processing model(s) 4 can process the data from input(s) 2 to obtain an input sequence 5. Input sequence 5 can include one or more input elements 5-1, 5-2, . . . , 5-M, etc. obtained from input(s) 2. Sequence processing model 4 can process input sequence 5 using prediction layer(s) 6 to generate an output sequence 7. Output sequence 7 can include one or more output elements 7-1, 7-2, . . . , 7-N, etc. generated based on input sequence 5. The system can generate output(s) 3 based on output sequence 7.

Sequence processing model(s) 4 can include one or multiple machine-learned model components configured to ingest, generate, or otherwise reason over sequences of information. For example, some example sequence processing models in the text domain are referred to as “Large Language Models,” or LLMs. See, e.g., PaLM 2 Technical Report, Google, https://ai.google/static/documents/palm2techreport.pdf (n.d.). Other example sequence processing models can operate in other domains, such as image domains, see, e.g., Dosovitskiy et al., An Image is Worth 16×16 Words: Transformers for Image Recognition at Scale, arXiv: 2010.11929v2 (Jun. 3, 2021), audio domains, see, e.g., Agostinelli et al., MusicLM: Generating Music From Text, arXiv: 2301.11325v1 (Jan. 26, 2023), biochemical domains, see, e.g., Jumper et al., Highly accurate protein structure prediction with AlphaFold, 596 Nature 583 (Aug. 26, 2021), by way of example. Sequence processing model(s) 4 can process one or multiple types of data simultaneously. Sequence processing model(s) 4 can include relatively large models (e.g., more parameters, computationally expensive, etc.), relatively small models (e.g., fewer parameters, computationally lightweight, etc.), or both.

In general, sequence processing model(s) 4 can obtain input sequence 5 using data from input(s) 2. For instance, input sequence 5 can include a representation of data from input(s) 2 in a format understood by sequence processing model(s) 4. One or more machine-learned components of sequence processing model(s) 4 can ingest the data from input(s) 2, parse the data into pieces compatible with the processing architectures of sequence processing model(s) 4 (e.g., via “tokenization”), and project the pieces into an input space associated with prediction layer(s) 6 (e.g., via “embedding”).

Sequence processing model(s) 4 can ingest the data from input(s) 2 and parse the data into a sequence of elements to obtain input sequence 5. For example, a portion of input data from input(s) 2 can be broken down into pieces that collectively represent the content of the portion of the input data. The pieces can provide the elements of the sequence.

Elements 5-1, 5-2, . . . , 5-M can represent, in some cases, building blocks for capturing or expressing meaningful information in a particular data domain. For instance, the elements can describe “atomic units” across one or more domains. For example, for textual input source(s), the elements can correspond to groups of one or more words or sub-word components, such as sets of one or more characters.

For example, elements 5-1, 5-2, . . . , 5-M can represent tokens obtained using a tokenizer. For instance, a tokenizer can process a given portion of an input source and output a series of tokens (e.g., corresponding to input elements 5-1, 5-2, . . . , 5-M) that represent the portion of the input source. Various approaches to tokenization can be used. For instance, textual input source(s) can be tokenized using a byte-pair encoding (BPE) technique. See, e.g., Kudo et al., SentencePiece: A simple and language independent subword tokenizer and detokenizer for Neural Text Processing, Proceedings of the 2018 Conference on Empirical Methods in Natural Language Processing (System Demonstrations), pages 66-71 (Oct. 31-Nov. 4, 2018), https://aclanthology.org/D18-2012.pdf. Image-based input source(s) can be tokenized by extracting and serializing patches from an image.

In general, arbitrary data types can be serialized and processed into input sequence 5. It is to be understood that element(s) 5-1, 5-2, . . . , 5-M depicted in FIG. 7 can be the tokens or can be the embedded representations thereof.

Prediction layer(s) 6 can predict one or more output elements 7-1, 7-2, . . . , 7-N based on the input elements. Prediction layer(s) 6 can include one or more machine-learned model architectures, such as one or more layers of learned parameters that manipulate and transform the input(s) to extract higher-order meaning from, and relationships between, input element(s) 5-1, 5-2, . . . , 5-M. In this manner, for instance, example prediction layer(s) 6 can predict new output element(s) in view of the context provided by input sequence 5.

Prediction layer(s) 6 can evaluate associations between portions of input sequence 5 and a particular output element. These associations can inform a prediction of the likelihood that a particular output follows the input context. For example, consider the textual snippet, “The carpenter's toolbox was small and heavy. It was full of ______.” Example prediction layer(s) 6 can identify that “It” refers back to “toolbox” by determining a relationship between the respective embeddings. Example prediction layer(s) 6 can also link “It” to the attributes of the toolbox, such as “small” and “heavy.” Based on these associations, prediction layer(s) 6 can, for instance, assign a higher probability to the word “nails” than to the word “sawdust.”

A transformer is an example architecture that can be used in prediction layer(s) 4. See, e.g., Vaswani et al., Attention Is All You Need, arXiv: 1706.03762v7 (Aug. 2, 2023). A transformer is an example of a machine-learned model architecture that uses an attention mechanism to compute associations between items within a context window. The context window can include a sequence that contains input sequence 5 and potentially one or more output element(s) 7-1, 7-2, . . . , 7-N. A transformer block can include one or more attention layer(s) and one or more post-attention layer(s) (e.g., feedforward layer(s), such as a multi-layer perceptron).

Prediction layer(s) 6 can include other machine-learned model architectures in addition to or in lieu of transformer-based architectures. For example, recurrent neural networks (RNNs) and long short-term memory (LSTM) models can also be used, as well as convolutional neural networks (CNNs). In general, prediction layer(s) 6 can leverage various kinds of artificial neural networks that can understand or generate sequences of information.

Output sequence 7 can include or otherwise represent the same or different data types as input sequence 5. For instance, input sequence 5 can represent textual data, and output sequence 7 can represent textual data. Input sequence 5 can represent image, audio, or audiovisual data, and output sequence 7 can represent textual data (e.g., describing the image, audio, or audiovisual data). It is to be understood that prediction layer(s) 6, and any other interstitial model components of sequence processing model(s) 4, can be configured to receive a variety of data types in input sequence(s) 5 and output a variety of data types in output sequence(s) 7.

Output sequence 7 can have various relationships to input sequence 5. Output sequence 7 can be a continuation of input sequence 5. Output sequence 7 can be complementary to input sequence 5. Output sequence 7 can translate, transform, augment, or otherwise modify input sequence 5. Output sequence 7 can answer, evaluate, confirm, or otherwise respond to input sequence 5. Output sequence 7 can implement (or describe instructions for implementing) an instruction provided via input sequence 5.

Output sequence 7 can be generated autoregressively. For instance, for some applications, an output of one or more prediction layer(s) 6 can be passed through one or more output layers (e.g., softmax layer) to obtain a probability distribution over an output vocabulary (e.g., a textual or symbolic vocabulary) conditioned on a set of input elements in a context window. In this manner, for instance, output sequence 7 can be autoregressively generated by sampling a likely next output element, adding that element to the context window, and re-generating the probability distribution based on the updated context window, and sampling a likely next output element, and so forth.

Output sequence 7 can also be generated non-autoregressively. For instance, multiple output elements of output sequence 7 can be predicted together without explicit sequential conditioning on each other. See, e.g., Saharia et al., Non-Autoregressive Machine Translation with Latent Alignments, arXiv: 2004.07437v3 (Nov. 16, 2020).

Output sequence 7 can include one or multiple portions or elements. In an example content generation configuration, output sequence 7 can include multiple elements corresponding to multiple portions of a generated output sequence (e.g., a textual sentence, values of a discretized waveform, computer code, etc.). In an example classification configuration, output sequence 7 can include a single element associated with a classification output. For instance, an output “vocabulary” can include a set of classes into which an input sequence is to be classified. For instance, a vision transformer block can pass latent state information to a multilayer perceptron that outputs a likely class value associated with an input image.

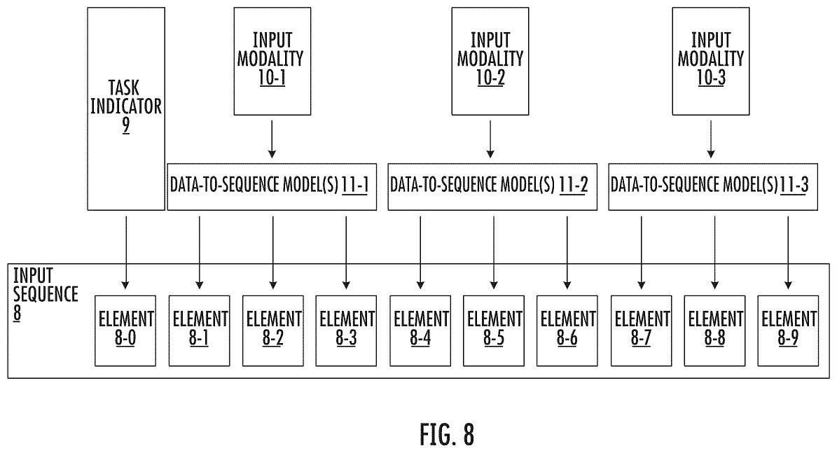

FIG. 8 is a block diagram of an example technique for populating an example input sequence 8. Input sequence 8 can include various functional elements that form part of the model infrastructure, such as an element 8-0 obtained from a task indicator 9 that signals to any model(s) that process input sequence 8 that a particular task is being performed (e.g., to help adapt a performance of the model(s) to that particular task). Input sequence 8 can include various data elements from different data modalities. For instance, an input modality 10-1 can include one modality of data. A data-to-sequence model 11-1 can process data from input modality 10-1 to project the data into a format compatible with input sequence 8 (e.g., one or more vectors dimensioned according to the dimensions of input sequence 8) to obtain elements 8-1, 8-2, 8-3. Another input modality 10-2 can include a different modality of data. A data-to-sequence model 11-2 can project data from input modality 10-2 into a format compatible with input sequence 8 to obtain elements 8-4, 8-5, 8-6. Another input modality 10-3 can include yet another different modality of data. A data-to-sequence model 11-3 can project data from input modality 10-3 into a format compatible with input sequence 8 to obtain elements 8-7, 8-8, 8-9.

Input sequence 8 can be the same as or different from input sequence 5. Input sequence 8 can be a multimodal input sequence that contains elements that represent data from different modalities using a common dimensional representation. For instance, an embedding space can have P dimensions. Input sequence 8 can be configured to contain a plurality of elements that have P dimensions. In this manner, for instance, example implementations can facilitate information extraction and reasoning across diverse data modalities by projecting data into elements in the same embedding space for comparison, combination, or other computations therebetween.

For example, elements 8-0, . . . , 8-9 can indicate particular locations within a multidimensional embedding space. Some elements can map to a set of discrete locations in the embedding space. For instance, elements that correspond to discrete members of a predetermined vocabulary of tokens can map to discrete locations in the embedding space that are associated with those tokens. Other elements can be continuously distributed across the embedding space. For instance, some data types can be broken down into continuously defined portions (e.g., image patches) that can be described using continuously distributed locations within the embedding space.

In some implementations, the expressive power of the embedding space may not be limited to meanings associated with any particular set of tokens or other building blocks. For example, a continuous embedding space can encode a spectrum of high-order information. An individual piece of information (e.g., a token) can map to a particular point in that space: for instance, a token for the word “dog” can be projected to an embedded value that points to a particular location in the embedding space associated with canine-related information. Similarly, an image patch of an image of a dog on grass can also be projected into the embedding space. In some implementations, the projection of the image of the dog can be similar to the projection of the word “dog” while also having similarity to a projection of the word “grass,” while potentially being different from both. In some implementations, the projection of the image patch may not exactly align with any single projection of a single word. In some implementations, the projection of the image patch can align with a combination of the projections of the words “dog” and “grass.” In this manner, for instance, a high-order embedding space can encode information that can be independent of data modalities in which the information is expressed.

Task indicator 9 can include a model or model component configured to identify a task being performed and inject, into input sequence 8, an input value represented by element 8-0 that signals which task is being performed. For instance, the input value can be provided as a data type associated with an input modality and projected along with that input modality (e.g., the input value can be a textual task label that is embedded along with other textual data in the input; the input value can be a pixel-based representation of a task that is embedded along with other image data in the input; etc.). The input value can be provided as a data type that differs from or is at least independent from other input(s). For instance, the input value represented by element 8-0 can be learned within a continuous embedding space.

Input modalities 10-1, 10-2, and 10-3 can be associated with various different data types (e.g., as described above with respect to input(s) 2 and output(s) 3).

Data-to-sequence models 11-1, 11-2, and 11-3 can be the same or different from each other. Data-to-sequence models 11-1, 11-2, and 11-3 can be adapted to each respective input modality 10-1, 10-2, and 10-3. For example, a textual data-to-sequence model can subdivide a portion of input text and project the subdivisions into element(s) in input sequence 8 (e.g., elements 8-1, 8-2, 8-3, etc.). An image data-to-sequence model can subdivide an input image and project the subdivisions into element(s) in input sequence 8 (e.g., elements 8-4, 8-5, 8-6, etc.). An arbitrary datatype data-to-sequence model can subdivide an input of that arbitrary datatype and project the subdivisions into element(s) in input sequence 8 (e.g., elements 8-7, 8-8, 8-9, etc.).

Data-to-sequence models 11-1, 11-2, and 11-3 can form part of machine-learned sequence processing model(s) 4. Data-to-sequence models 11-1, 11-2, and 11-3 can be jointly trained with or trained independently from machine-learned sequence processing model(s) 4. Data-to-sequence models 11-1, 11-2, and 11-3 can be trained end-to-end with machine-learned sequence processing model(s) 4.

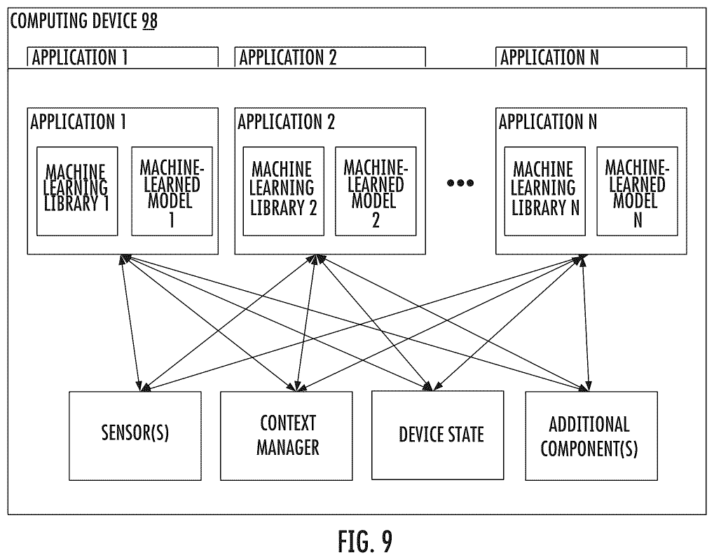

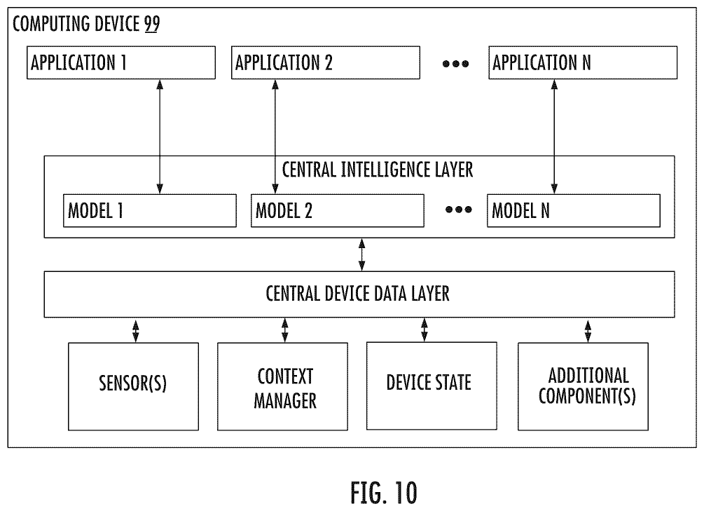

FIG. 9 is a block diagram of an example computing device 98 that performs according to example embodiments of the present disclosure. Computing device 98 can be a user computing device or a server computing device (e.g., computing device 50, server computing system(s) 60, etc.). Computing device 98 can implement model host 31. For instance, computing device 98 can include a number of applications (e.g., applications 1 through N). Each application can contain its own machine learning library and machine-learned model(s). For example, each application can include a machine-learned model. Example applications include a text messaging application, an email application, a dictation application, a virtual keyboard application, a browser application, etc. As illustrated in FIG. 10, each application can communicate with a number of other components of the computing device, such as, for example, one or more sensors, a context manager, a device state component, or additional components. In some implementations, each application can communicate with each device component using an API (e.g., a public API). In some implementations, the API used by each application is specific to that application.

FIG. 10 is a block diagram of an example computing device 99 that performs according to example embodiments of the present disclosure. Computing device 99 can be the same as or different from computing device 98. Computing device 99 can be a user computing device or a server computing device (e.g., computing device 50, server computing system(s) 60, etc.). Computing device 98 can implement model host 31. For instance, computing device 99 can include a number of applications (e.g., applications 1 through N). Each application can be in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer can include a number of machine-learned models. For example, as illustrated in FIG. 11, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of computing device 99.

The central intelligence layer can communicate with a central device data layer. The central device data layer can be a centralized repository of data for computing device 99. As illustrated in FIG. 11, the central device data layer can communicate with a number of other components of the computing device, such as, for example, one or more sensors, a context manager, a device state component, or additional components. In some implementations, the central device data layer can communicate with each device component using an API (e.g., a private API).

The technology discussed herein makes reference to servers, databases, software applications, and other computer-based systems, as well as actions taken, and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

What is claimed is:

1. A computer-implemented method to perform iterative narrowing of options with artificial intelligence-based agents, the method comprising:
determining, by a computing system with one or more processors, a first set of candidate outcome values for an issue, wherein the first set of candidate outcome values are determined based, at least in part, on one or more preferences of a first user;
receiving, by the computing system, a second set of candidate outcome values from a second communication agent associated with a second user;
determining, by the computing system, a third set of candidate outcome values based on the first set and the second set of candidate outcome values;
providing, by the computing system, the third set of candidate outcome values as input to a first communication agent associated with the first user;
receiving, by the computing system, a fourth set of candidate outcome values as an output from the first communication agent, wherein the fourth set of candidate outcome values has fewer candidate outcome values than the third set of candidate outcome values;
transmitting, by the computing system, the fourth set of candidate outcome values to the second communication agent located at a second computing system as input;
continuing to iteratively send and receive a set of a candidate outcome values between the first communication agent and the second communication agent until a final candidate outcome value remains in the set of candidate outcome values; and
transmitting, by the computing system, the final candidate outcome value to a first user associated with the first communication agent and a second user associated with the second communication agent.

2. The computer-implemented method of claim 1, wherein determining, by the computing system, a third set of candidate outcome values based on the first set and the second set of candidate outcome values further comprises:
comparing, by the computing system, the first set of candidate outcome values and the second set of candidate outcome values to identify one or more candidate outcome values that are present in both sets; and
generating, by the computing system, the third set of candidate outcome values based on the one or more candidate outcome values that are present in both sets.

3. The computer-implemented method of claim 2, wherein determining, by the computing system, a third set of candidate outcome values based on the first set and the second set of candidate outcome values further comprises:
determining, by the computing system, that the first set of candidate outcome values and the second set of candidate have no candidate outcome values that are present in both sets;
responsive to determining that the first set of candidate outcome values and the second set of candidate have no candidate outcome values that are present in both sets:
generating an input to the first communication agent requesting that a predetermined number of candidate outcome values to be added to the first set;
generating an input to the second communication agent requesting that the predetermined number of candidate outcome values to be added to the set; and
continuing to generate requests for additional candidate outcome values until the first set of candidate outcome values and the second set of candidate have at least one candidate outcome value that is present in both the first set and the second set.

4. The computer-implemented method of claim 3, wherein the predetermined number is 1.

5. The computer-implemented method of claim 3, wherein the predetermined is determined based on a number of candidate outcome values in the third set of candidate outcome values.

6. The computer-implemented method of claim 1, wherein the input to the first communication agent includes instructions to remove at least one candidate outcome value from the third set of candidate outcome values.

7. The computer-implemented method of claim 1, wherein the output from the first model includes a natural language prompt for the second communication agent that instructions the second communication agent includes instructions to remove at least one candidate outcome value from the fourth set of candidate outcome values.

8. The computer-implemented method of claim 1, wherein the fourth set of candidate outcome values are transmitted to the second communication agent using email.

9. The computer-implemented method of claim 1, wherein the first communication agent is trained to generate a preference score for each candidate outcome value in the third set of candidate outcome values and the method further comprises:
removing, by the computing system, a predetermined number of candidate options from the third set of candidate outcome values based on the preference score to generate the fourth set of candidate outcome values.

10. The computer-implemented method of claim 9, wherein the preference score for a respective candidate outcome value is determined based on stored information about a first user's preferences.

11. The computer-implemented method of claim 1, wherein each candidate outcome value is associated with a performance of a particular task.

12. The computer-implemented method of claim 11, the method further comprising:
transmitting, by the computing system, instructions to perform a task based on a final candidate outcome value.

13. The computer-implemented method of claim 12, wherein the task is displaying an advertisement associated with the final candidate outcome value.

14. The computer-implemented method of claim 12, wherein the task is booking a reservation at a restaurant associated with the final candidate outcome value.

15. The computer-implemented method of claim 12, wherein the task is adding a meeting to a calendar based on the final candidate outcome value.

16. The computer-implemented method of claim 1, wherein the method further comprises:
dividing, by the computing system, the third set of candidate outcome values into a plurality of distinct subsets;
performing, by the computing system, a process of iteratively removing candidates from each subset in the plurality of distinct subsets in parallel;
gathering, by the computing system, a final candidate outcome value for each subset into a final set of candidate outcome values; and
performing, by the computing system, the process of iteratively removing candidate outcome values from the final set of candidate outcome values to determine final candidate outcome value.

17. The computer-implemented method of claim 1, wherein the method further comprises:
applying, by the computing system, a filter to the third set of candidate outcome values to reduce a number of candidate outcome values in the third set of candidate outcome values.

18. A non-transitory computer-readable medium storing instructions that, when executed by one or more computing devices, cause the one or more computing devices to perform operations comprising:
determining a first set of candidate outcome values for an issue, wherein the first set of candidate outcome values are determined based, at least in part, on one or more preferences of a first user;
receiving a second set of candidate outcome values from a second communication agent associated with a second user;
determining a third set of candidate outcome values based on the first set and the second set of candidate outcome values;
providing the third set of candidate outcome values as input to a first communication agent associated with the first user;
receiving a fourth set of candidate outcome values as an output from the first communication agent, wherein the fourth set of candidate outcome values has fewer candidate outcome values than the third set of candidate outcome values;
transmitting the fourth set of candidate outcome values to the second communication agent located at a second computing system as input;
continuing to iteratively send and receive a set of a candidate outcome values between the first communication agent and the second communication agent until a final candidate outcome value remains in the set of candidate outcome values; and
transmitting the final candidate outcome value to a first user associated with the first communication agent and a second user associated with the second communication agent.

19. A computing system, comprising:
one or more processors; and
one or more non-transitory computer-readable media that collectively store an artificial intelligence-based communication agent;
wherein, when executed by the one or more processors, the artificial intelligence-based communication agent is configured to perform a collaborative and iterative narrowing process to select a final outcome value for an item from a plurality of possible outcome values;
wherein the collaborative and iterative narrowing process comprises, for each of a plurality of narrowing iterations:
receiving a communication from one or more other communication agents, wherein the communication specifies a current set of possible outcome values for the item;
executing a machine-learned model to select one or more of the possible outcome values to be removed from the current set of possible outcome values;
updating the current set of possible outcome values by removing the selected one or more possible outcome values from the current set of possible outcome values; and
transmitting the updated current set of possible outcome values to the one or more other communication agents.

20. The computing system of claim 19, wherein the machine-learned model comprises a sequence processing model configured for language modeling.
